(19) United States
(12) Patent Application Publication
(10) Pub. No.: US 2021/0279110 A1
(43) Pub. Date: Sep. 9, 2021

(54) STREAMING RESOURCE MANAGEMENT

(71) Applicant: PayPal, Inc., San Jose, CA (US)

(72) Inventor: Vladimir Dubrosvkii, Singapore (SG)

(21) Appl. No.: 16/623,686

(22) PCT Filed: Dec. 28, 2018
(86) PCT No.: PCT/RU2018/000902

§ 371 Date: Dec. 17, 2019

(51) Int. Cl. G06F 9/50; G06F 9/30; G06F 9/54

(52) U.S. Cl. CPC G06F 9/5038; G06F 9/3009; G06F 2209/548; G06F 2209/504; G06F 9/546

(57) ABSTRACT

Systems and methods for allocating processes to queues are provided, which provides more efficient execution of batch jobs in various embodiments. Queue priorities are assigned while process priorities and queue limits are assigned to processes. A set of queues is determined by matching the queue priority to the process priority of a process. Batch numbers for the set of queues are determined, each batch number indicating groups of messages to be processed. First queues and second queues from the set of queues are determined, the first queues having higher batch numbers than the second queues and a number of queues up to a queue limit of the process. The first queues are processed using the process. The queue priority of the second queues is decremented and the second queues are processed by another process with the process priority that matches the decremented queue priority of the second queues.

### TECHNICAL FIELD

The disclosure generally relates to managing and allocating computing resources, and more specifically to allocating resources that process jobs stored in queues, according to various embodiments.

### BACKGROUND

Processing jobs (e.g. tasks that require computational resources to execute) may be stored within queues for future processing. In some instances, execution of these jobs may be performed in a sub-optimal manner—particularly when new work for the job queues may be arriving at a rate faster than a job is being processed. Lag in execution and other negative side effects may therefore occur, e.g., when allocated resources are not able to remove messages from queues and process the messages at a necessary rate.

### BRIEF DESCRIPTION OF THE DRAWINGS

FIG. 1 is an example of a system usable with various techniques and embodiments described herein.

FIGS. 2A-E are block diagrams illustrating queues allocated to processes, according to an embodiment.

FIG. 3 is a flowchart of a method for allocating queues to processes, according to an embodiment.

FIG. 4 is a block diagram of a computer system suitable for implementing one or more components or operations in FIGS. 1-3 according to an embodiment.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Processes that process messages in multiple queues include optimization techniques that determine how the system resources are allocated to processes processing the queues. Example resources may be a processor, such as a central processing unit (“CPU”) or a graphics processing unit (“GPU”), and a memory, such as a random-access memory (“RAM”). The optimization techniques also determine how the lagging queues may be processed and how to avoid or minimize the lagging queues. The lagging queues are queues where a number of messages stored in the queues increases because new messages are written into the queues at a faster rate than old messages are removed from the queues and are processed. Note that while specific examples are given herein regarding message queues, the techniques described herein are applicable to other types of queue processing systems and are not limited as such.

In a first type of system, multiple processes may process messages in a queue, one process per queue. In this way, all queues have equal priority and equal access to the system resources. However, if one of the queues begins to lag because a process for that queue does not have enough resources to process the messages in the queue, this first type system may not be able to speed up the processing for the lagging queue. At the same time, a queue that stores fewer messages than a process can process during the processing cycle, may use more system resources than are required to process the queue. Thus, in such a first type of system, queues that are getting busier (i.e. receiving more messages to process) may be throttled unnecessarily while queues that are getting less busy (i.e. processing more messages outbound than are being added to the queue) may have more resources prescribed than are needed.

In another type of system, the system can use a single process to process all queues. In this system, the process will process all queues, before returning for a second round of processing. In this case, queues that have higher throughput than other queues may have access to more resources, and messages in these queues may be processed faster than under a system that assigns one process per queue, while queues that have lower throughput have less access to resources. However, in this system all queues may fall behind at once. This may occur when one or more queues begin to lag and slow down processing of the other queues. This in turn may lead to more messages stored in the non-lagging queues causing the non-lagging queues to also lag, until all or most queues in the system are lagging.

The embodiments below describe a system where multiple processes optimize queue processing, according to various embodiments. The system may include multiple queues and multiple independent processing units called processes. Each queue may be associated with a queue priority that may be changed (increased, decreased, and/or set to a default queue priority) by the processes. Each process may be associated with a process priority and a queue limit. The process priority of the process may correspond to the amount of resources, such as CPU time and RAM, that is available to that process. In some embodiments, as the process priority increases, a process may obtain more resources. In this way, a process that is associated with a larger process priority may have access to a larger amount of resources than a process that is associated with a smaller process priority. The queue limit may indicate the number of queues that may be processed by a process.

In an embodiment, processes may determine the subsets of queues that may be processed by each process by matching queue priorities with process priorities. Once the processes determine the subsets of queues to be processed by the respective processes, each process may determine whether the queues in the subset of queues may be processed by that process.

For example, each process may determine whether the number of queues in the subset of queues exceeds the queue limit for that process. If the number of queues does not exceed the queue limit, the queues in the subset of queues may be processed by the process. If the number of queues in the subset of queues exceeds the queue limit, the process may determine the batch number of each queue in the subset of queues. The term batch number, in various embodiments, may refer to a maximum number of messages to be processed from a queue within a particular time interval. Further, note that processing a message in a queue may involve operations including adding a destination address for the message and placing content within the message which can be customized according to a particular user and/or category of users (e.g. United States residents might get one version of content; Canada residents might get another version of content; a male individual may have a first content item (e.g. an advertisement for men's gloves) placed in a particular location within the message while a female individual might have a second content item placed in the same particular location within the message (e.g. an advertisement for women's boots). Processing the message may also include then transmitting message (e.g. to an email address or phone number via text/SMS message) and removing that particular outbound message from a queue.

The process may determine the batch number for each queue by dividing the number of messages in the queue by a configurable batch number size. Once the process determines the batch numbers for the queues in the subset set of queues, the process may use the batch numbers to determine the first set of queues and the second set of queues. The first set of queues may have queue(s) with higher batch numbers and with a number of queues up to the queue limit for the process. The second set of queues may have queue(s) with the lower batch numbers than the queue(s) in the first set of queues. The first set of queues may be processed by the process for a configurable number of cycles or for a configurable time interval. The queue priorities of queues in the second set of queues are decreased by one. In this way, the queues in the second set of queues may be processed by another process that is associated with a process priority that matches the decreased queue priority.

In an embodiment, as the queues are processed for a configurable number of cycles or a configurable time interval, the processes allocated to the queues may remove one or more messages from the queues and process the messages. As the processes process the messages in the queues, more messages may arrive at a server and are added to the queues.

In an embodiment, after a process processes the first set of queues for a configurable number of cycles or a configurable time interval, the process may re-evaluate whether queues in the first subset of queues may be reallocated to other processes. For example, if the batch number of the one or more queues in the first set of queues decreased from the batch numbers of the one or more queues before the processing, the queue priority for the one or more queues remains the same, and the one or more queues are processed by the same process for the next configurable number of cycles or a next configurable time interval. This is because the process determines that the one or more queues do not lag and the process has sufficient resources to process the one or more queues. In another example, if the batch number of the one or more queues increased from before the processing, the queue priority of the one or more queues is increased by one. This is because the process determines that the process does not have enough resources to process the one or more queues and the queues may begin to lag. Accordingly, when the process increments the queue priority of the one or more queues, the one or more queues are processed by another process that has a higher process priority and thus has access to more resources. Additionally, the other process may have a lower queue limit which means that the other process will also process fewer queues. In another example, if the batch numbers of the one or more queues is zero, then the queue priority for the one or more queues is set to zero. In this way, the one or more queues are processed using the process with the process priority of zero. This is because the process with process priority that corresponds to zero determines that the one or more queues are empty and can be processed by a process that has the fewest resources.

Stated another way, the techniques can measure queue processing and adjust dynamically to provide more efficient message throughput. Throughput of these messages may involve customized content creation and addition such as insertion of content into an electronic message like an email, via use of a template, in some embodiments.

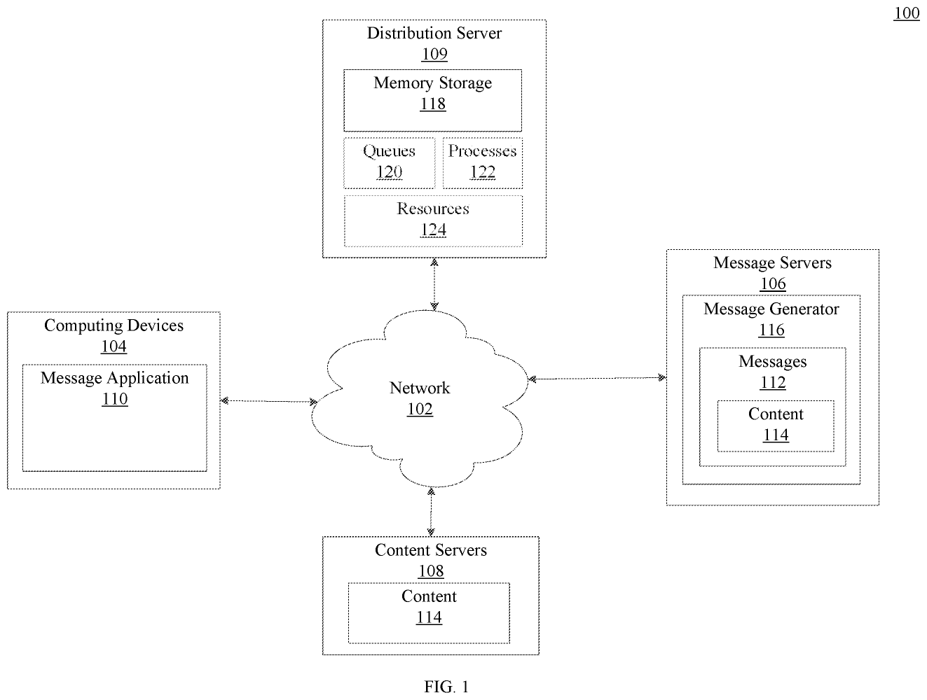

FIG. 1 is an exemplary system 100 where embodiments can be implemented. Although embodiments described below are discussed with reference to system 100, the disclosure is not limited to these embodiments and may also be in included in other types of computing systems and environments.

System 100 includes a network 102. Network 102 may be implemented as a single network or a combination of multiple networks. For example, in various embodiments, network 102 may include the Internet or one or more intranets, landline networks, wireless networks, and/or other appropriate types of networks. Network 102 may be a small-scale communication network, such as a private or local area network, or a larger scale network, such as a wide area network.

Various devices may be accessible to network 102 and may include computing device(s) 104, message server(s) 106, content server(s) 108 and distribution server(s) 109. Computing devices 104 may be portable and non-portable electronic devices under control of a user and configured to transmit, receive, and manipulate messages from message server(s) 106 and distribution server(s) 109 over network 102. Example computing devices 104 include desktop computers, laptop computers, tablets, smartphones, wearable computing devices, eyeglasses that incorporate computing devices, implantable computing devices, and the like. Note that components and functionality described relative to FIG. 1 may be combined in various ways in different embodiments—e.g., in some instances, message server(s) 106 could be combined with all or a portion of content server(s) 108 and/or distribution server(s) 109.

Computing devices 104 may include one or more message applications 110. Message applications 110 may be pre-installed on computing devices 104, installed on computing devices 104 using portable memory storage devices, such as compact disks or thumb-drives, or be downloaded to computing devices 104 from message server(s) 106. Message applications 110 may execute on computing devices 104 and receive messages 112 from message server(s) 106, distribution server(s) 109 or from another server.

Example message applications 110 may be electronic mail applications, messaging applications, instant messaging applications, or other types of applications that are able to receive, transmit and process messages 112. Example messages 112 may be electronic messages, instant messages, text messages, and the like. Further, although embodiments below may be described with respect to message applications 110, the embodiments are not limited to message applications 110, and may also include payment transaction applications, analytics applications, security applications for implementing client-side security features, programmatic client applications for interfacing with appropriate application programming interfaces (APIs) over network 102, location detection applications, such as a mapping, compass, and/or global positioning system (GPS) application, social networking applications and/or merchant applications that transmit data instead of messages 112. Additionally, applications may be service applications that permit a user of computing device 104 to receive, request and/or view information for products and/or services, and also permit the user to purchase the selected products and/or services.

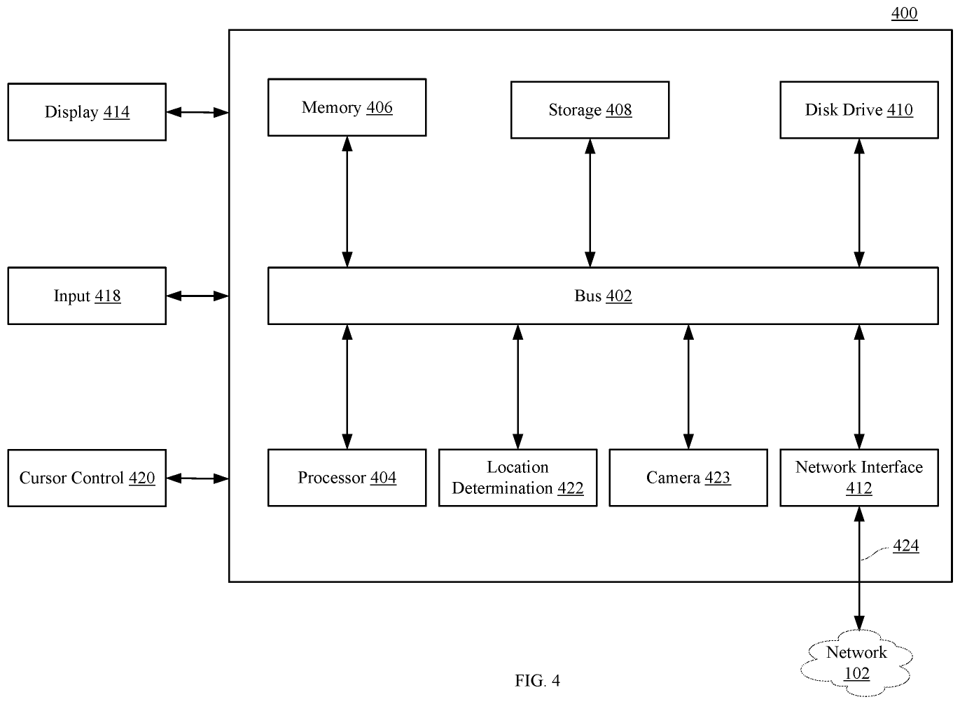

In an embodiment, message applications 110 may utilize numerous components included in computing device 104 to receive input, store and display message and message content generated on message servers 106 as discussed below, and communicate with network 102. Example components are discussed in detail in FIG. 4.

As discussed above, one or more message servers 106 may be connected to network 102. Message server 106 may be maintained by a service provider, such as PAYPAL®, a telephonic service provider, social networking service, and/or other service providers. Message server 106 may be software that executes on a computing device configured for large scale processing.

In an embodiment, message server 106 may include a message generator 116. Message generator 116 may generate messages 112 that message server 106 may transmit to computing devices 104.

Message generator 116 may generate messages 112 that include content 114. Content 114 may include textual content, image content, video content, link(s) to content that may be obtained over network 102, or other types of data. Content 114 may vary among messages 112 or may be the same content in multiple messages 112.

While generating messages 112, message generator 116 may incorporate content 114 into messages 112. To incorporate content 114, message generator 116 may determine content type, such as textual content, image content, video content, link(s) to content, etc., that may be included in messages 112 and also the placement of content 114 in messages 112.

In some embodiments, message generator 116 may use a template to lay out content 114 in messages 112. A template may be a structure that may include a design pattern for displaying content 114. For example, the template may include a layout for an image, video, and/or textual content in a designated portion of message 112. When message generator 116 uses a template, message generator 116 may include content 114 that is an image, video, text, link, etc., into messages 112 in the designated portions. In this way, messages 112 may include different content 114 that may be laid out similarly or in the same way in different messages 112.

In an embodiment, message generator 116 may receive content 114 from content server 108. Content server 108 may be connected to network 102 and maintained by content provider, such as PAYPAL®, a telephonic service provider, social networking service, and/or other service providers. Content server 108 may be software that executes on a computing device configured for large scale processing. Although shown as distinct from message server 106, message server 106 and content server 108 may execute within the same or different computing devices.

In an embodiment, content server 108 may be a content source for content 114 and may generate content 114 that may be included in messages 112. For example, content server 108 may generate content 114 and transmit content 114 to message server 106 for inclusion into messages 112. Content server 108 may be connected to network 102 and maintained by message provider, such as PAYPAL®, a telephonic service provider, social networking service, and/or other service providers.

As discussed above, system 100 may include a distribution server 109. Distribution server 109 may be connected to network 102 and maintained by message provider, such as PAYPAL®, a telephonic service provider, social networking service, and/or other service providers. Distribution server 109 receive messages 112 from multiple sources, such as message servers 106 and distribute messages 112 to computing devices 104. Although shown separately from message server 106, distribution server 109 may be incorporated into message server 106.

To distribute messages 112 to computing devices 104 that are associated with the recipients of messages 112, distribution server 109 may include queues 120 and processes 122. Queues 120 and processes 122 receive, store, and process messages 112. As will be discussed below, each process in processes 122 may work as a separate processing unit and include logic for processing queues. In some embodiments, processing messages 112 includes transmitting messages 112 to various destinations, such as computing devices 104 associated with recipients of messages 112.

In an embodiment, queues 120 may be data structures that receive and store messages 112. Queues 120 may operate using a first-in first-out (FIFO) principle, where messages 112 first received in queues 120 are messages 112 that first exit queues 120 and are processed using processes 122. Further, as messages 112 are stored in or exit queues 120, new messages 112 may be received and stored in queues 120. Although embodiments below are described with respect to queues 120 that store messages 112, the embodiments are not limited to messages 112 and may apply to different computing structures and other types of data that may be stored in queues 120.

In an embodiment, queues 120 may store messages 112 before messages 112 are processed using processes 122. Processes 122 may be processes, threads, tasks, jobs, or anther computing entity that may retrieve messages 112 from queues 120 and process messages 112. As part of the processing, processes 122 may transmit messages 112 to various destinations, such as computing devices 104 that are associated with recipients of the messages.

In an embodiment, processes 122 may process messages 112 using resources 124. Resources 124 may be hardware and/or software resources, including processor (such as a central processing unit, a graphics processing unit, etc.) and memory (such as a random-access memory, a dynamic random access memory, etc.) discussed in FIG. 4.

Unlike certain queue types that may be processed using a single processor, or queues that are equally assigned to available processes, different number of queues 120 may be allocated to different processes 122. Additionally, different portions of resources 124 may be allocated to different processes 122. For example, each process in processes 122 may be associated with a process priority, and processes 122 with higher priority may have access to more processor time, more memory space, etc., than processes 122 with lower priority. Further, processes 122 may reallocate queues 120 between themselves based on a number of messages 112 that is received by and stored in queues 120, whether a process in processes 122 is able to process messages 122 in queues 120 without the queues beginning to lag, etc. In yet another example, processes 122 may allocate queues 120 among themselves while taking into consideration a queue limit associated with processes 122. Further embodiments of processes 122 allocating queues 120 are discussed below.

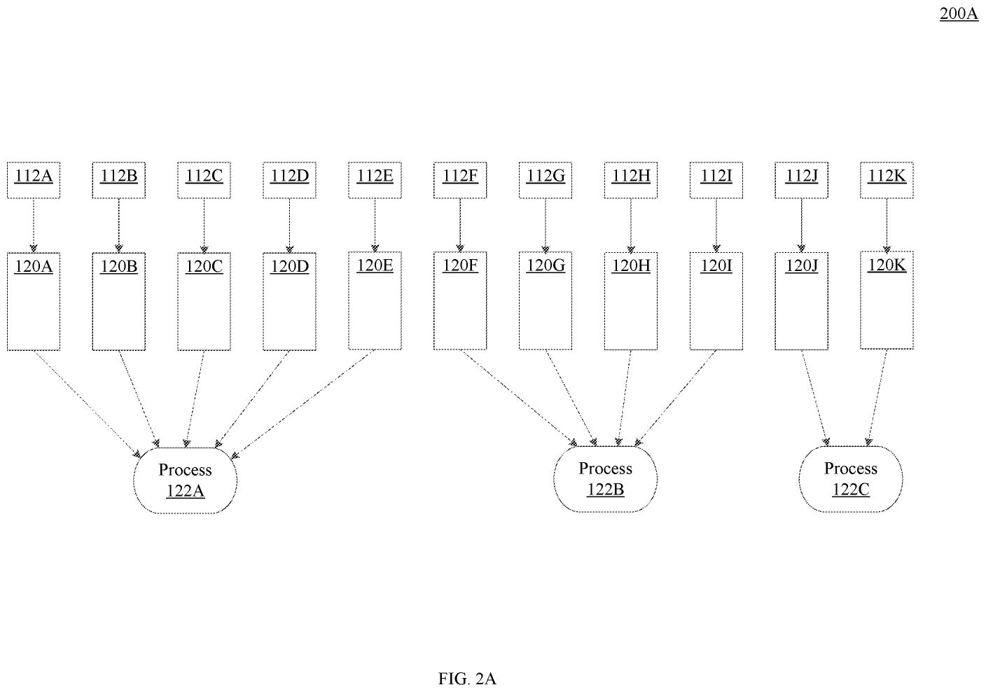

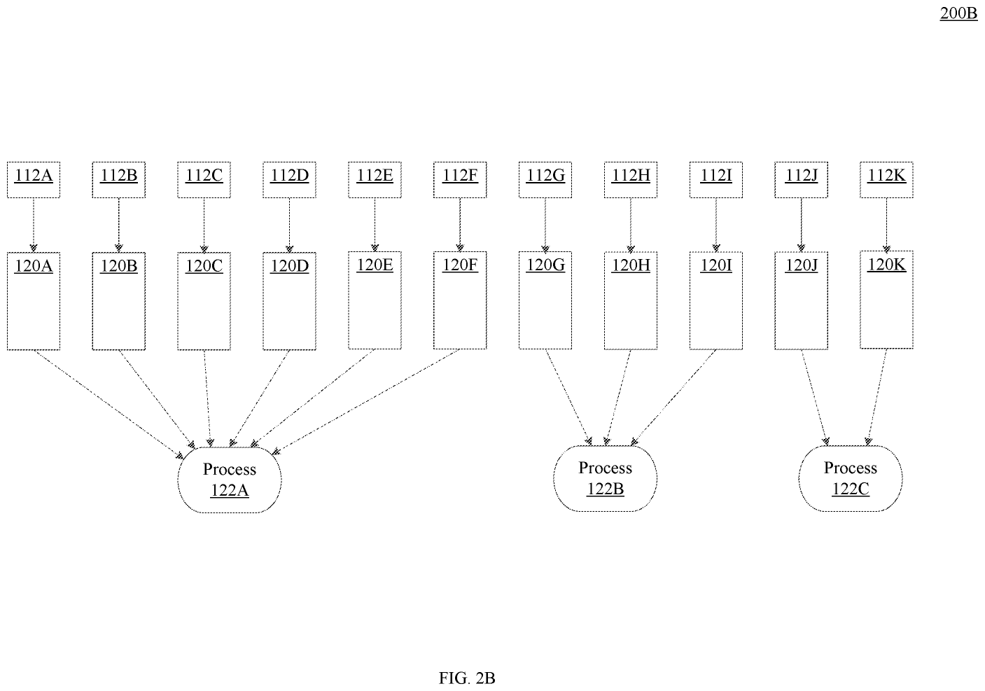

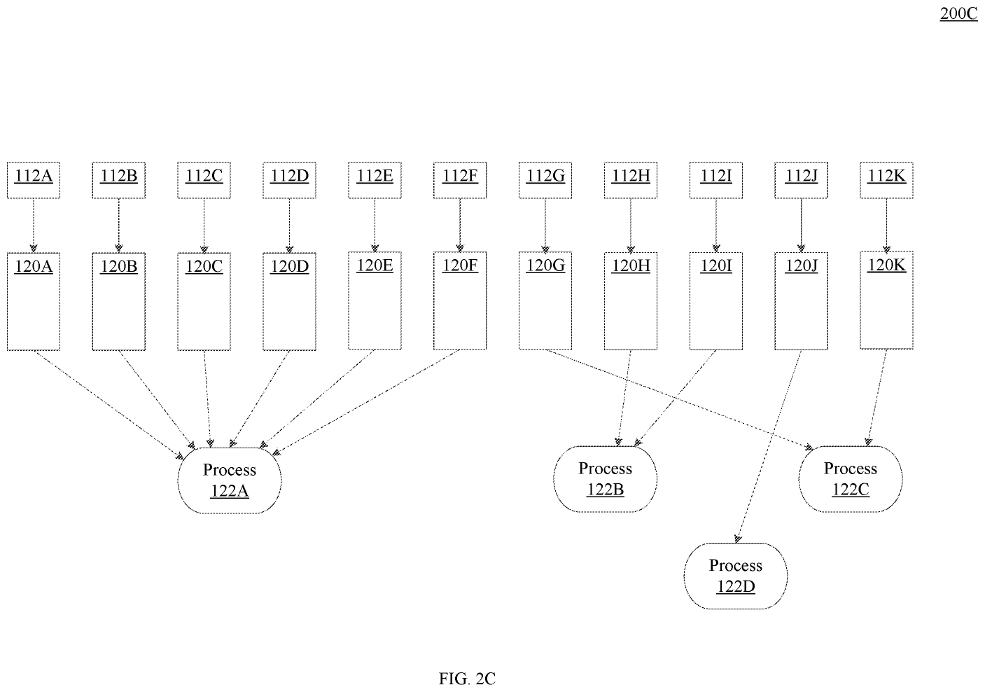

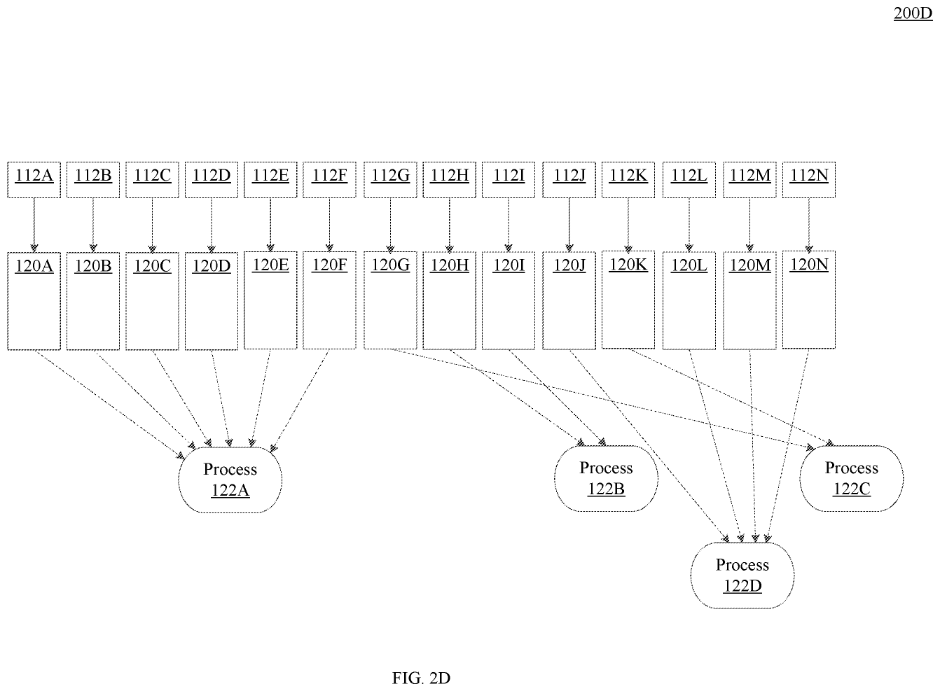

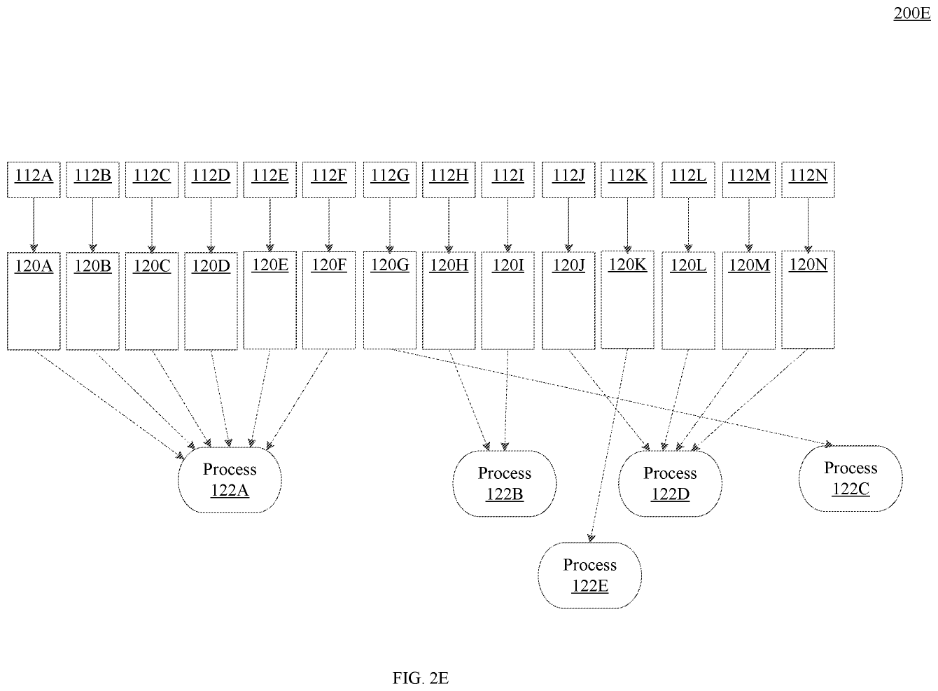

FIG. 2A is a block 200A that illustrates queues that are allocated to processes, according to an embodiment. As illustrated in FIG. 2A, distribution server 109 (not shown) may generate queues 120, such as queues 120A-K. Queues 120A-K may receive messages 112A-K. For example, queue 120A may receive and store messages 112A, queue 120B may receive and store messages 112B, queue 120C may receive and store messages 112C, etc. As discussed above, messages 112A-K may be messages 112 from different message servers 106 and include the same or different content 114.

In an embodiment, distribution server 109 may include processes 122, such as processes 122A-C. Processes 122A-C may be independent processing units that contain logic assigned to process queues 120A-K. As discussed above, processes 122A-C may process messages 112A-K that are received by and stored in queues 120A-K. Processes 122A-C may be associated with priorities, such as process priorities P0, P1, P2, P3. In some embodiment, process priority P0 may the lowest priority, while process priority P3 may be the highest priority. In one embodiment, processes 122A-C may have distinct priorities, while in another embodiment, some of processes 122A-C may have the same process priorities.

In an embodiment, process priorities P0, P1, P2, and P3 may correspond to a portion of resources 124 that may be allocated to processes 122A-C. In some embodiments, the higher the process priority of the process in processes 122A-C, the more resources from resources 124 distribution server 109 may allocate to the process in processes 122A-C. For example, if process 122A is associated with process priority P1, process 122B is associated with process priority P2, and process 122C is associated with process priority P3, then distribution server 109 may allocate the most resources in resources 124 to process 122C, fewer resources in resources 124 to process 122B, and the fewest resources in resources 124 to process 122A. In other embodiments, priorities P1, P2, and P3 may identify which resources from resources 124 may be allocated to processes 122A-C. For example, distribution server 109 may allocate more processor time to process 122C, less processor time to process 122B, and even less processor time to process 122A. In another example, process 122A that is associated with process priority P1 may have less memory resources in resources 124 than process 122B that is associated with process priority P2, and process 122B may have less memory resources in resources 124 than process 122C that is associated with process priority P3. In yet another embodiment, a process from processes 122A-C with higher priority may have fewer queues 120A-K allocated for processing than a process from processes 122A-C with lower priority.

In an embodiment, process priorities may be stored within processes 122A-C, within memory storage 118 that is included in or coupled to distribution server 109 discussed in FIG. 1. Example memory storage may be a database, or another memory associated with distribution server 109 that are discussed in FIG. 4.

In an embodiment, each one of processes 122A-C may also be assigned a queue limit that may be configured or reconfigured by respective processes 122A-C. The queue limit may determine the number of queues that processes 122A-C may process. For example, process 122A may have a queue limit=6, process 122B may have a queue limit=3 and process 122C may have a queue limit=2. In a further embodiment, the higher process priority of processes 122A-C, the lower the queue limit that is associated with processes 122A-C. For example, process 122A may have process priority P1 and queue limit=6, process 122B may have process priority P2 and queue limit=3, and process 122C may have process priority P3 and queue limit=2. In another example, process priority P0 may not have a queue limit or have an infinite queue limit and may have an infinite number of queues 120 assigned to process 122.

In an embodiment, processes 122A-C may have queue limits. Queue limits may be stored within respective processes 122A-C or within memory storage 118 of distribution server 109. In another embodiment, processes 122A-C may change queue limits based on the number of queues 120 and a number of processes 122 that may exist on distribution server 109.

In an embodiment, queues 120A-K may be associated with queue priorities, such as queue priorities Q0, Q1, Q2, and Q3. In some embodiments, queues 120A-K may initially be assigned the lowest priority Q0. As will be discussed below, queue priorities may be incremented and decremented by processes 122A-C. In some embodiments, process with the lowest priority P0 may not decrement queues in queues 120A-K that have the lowest queue priority Q0. In an embodiment, queue priorities that are associated with queues 120A-K and queue identifiers that correspond to queues 120A-K (example queue identifiers may be “120A-K”) may be stored in memory storage 118.

In an embodiment, processes 122A-C may use queue priorities to determine which processes 122A-C may process messages 112A-K in queues 120A-K. Processes 122A-C may also change (increase, decrease, or set to default) queue priorities for queues 120A-K, with multiple queues 120A-K having the same queue priority. As discussed above, Q0 may be the lowest (and default) queue priority, and Q3 may be the highest queue priority.

In an embodiment illustrated in FIG. 2A, suppose memory storage 118 stores queue priority Q1 for queues 120A-E, queue priority Q2 for queues 120F-I, and queue priority Q3 for queues 120J-K. Such queue priorities may be associated with queues 120A-K after processes 122A-C have already processed messages 112A-K as described below.

In an embodiment, processes 122A-C may process queues 120A-K using one or more cycles or for a configurable time interval that may be measured in seconds, minutes, etc. A cycle may be a configurable time period, a number of cycles used by a processor, etc. In some embodiments, processes 122A-C may start at the beginning of the one or more cycles, at which point processes 122A-C may read a list of queue identifiers (such as identifiers “120A-K”) of queues 120A-K from memory storage 118 and queue priorities that corresponds to identifiers “120A-K”) that match the process priorities of processes 122A-C. For example, process 122A that is associated with process priority P1 may read a queue list that includes identifiers “120A-E”, process 122B that is associated with process priority P2 may read a queue list that includes identifiers “120F-I”, and process 122C that is associated with process priority P3 may read a queue list that includes identifiers “120J-K”.

Once processes 122A-C read the respective queue lists, processes 122A-C may determine whether respective processes 122A-C may process some or all queues 120A-K that are identified in the respective queue lists. For example, process 122A may determine whether process 122A may process some or all queues in queues 120A-F, process 122B may process some or all queues in queues 120F-I, and process 122C may process some or all queues in queues 120J-120K. To determine whether processes 122A-C may process the respective queues 122A-K, processes 122A-C may determine whether the queues 120A-K that are in the respective queue lists exceed the queue limits associated with process 122A-C. For example, process 122A may determine whether the number of queues 120A-E in the queue list obtained by process 122A exceeds the queue limit=6. Process 122B may determine whether the number of queues 120F-I in the queue list obtained by process 122B exceeds the queue limit=3. Process 122C may determine whether the number of queues 120J-K in the queue list obtained by process 122C exceeds the queue limit=2.

With respect to process 122B, when process 122B determines that the number of queues (queues 120F-I) in the queue list obtained by process 122B exceeds the queue limit, process B may divide queues 120F-I into a first set of queues and a second set of queues. As will be discussed below, typically, the first set of queues includes queues with more messages 112 than the second set of queues. To determine the first set of queues and the second set of queues, process 122B may determine a number of batches that are included in queue 120F, queue 120G, queue 120H, and queue 120I. Process 122B may then determine the number of batches in queue 120F by dividing the number of messages 112F stored in queue 120F by a configurable batch size, the number of batches in queue 120G by dividing the number of messages 112G stored in queue 120G by the configurable batch size, and the number of batches in queue 120I by dividing the number of messages 112I stored in queue 120I by the configurable batch size.

Once process 122B determines the number of batches for queue 120F, queue 120G, queue 120H, and queue 120I, process 122B may determine the first set of queues as queues from 120F-I with higher batch numbers up to the queue limit of process 122B, and the second set of queues from queues 120F-I as the queues that exceed the queue limit and have batch numbers that are lower than the batch numbers of the first set of queues. For example, suppose the number of batches for queue 120F is 20, the number of batches for queue 120G is 30, the number of batches for queue 120H is 22 and the number of batches for queue 120I is 40. In this case, because process 122B has a queue limit=3, process 122B may select queues 120G-I into the first set of queues because queues 120G-I have higher batch numbers, and queue 120F into the second set of queues because queue 120F has a lower batch number than queues 120G-I.

In an embodiment, processes 122A-C may also decrement the priority of the one or more queues in the second set of queues. In this way, processes 122A-C may cause another process in processes 122A-C to processes the second set of queues. For example, process 122B may decrement the queue priority of queue 120F from Q2 to Q1 and store the new queue priority Q1 with queue identifier “120F” in memory storage 118. In this way, process 122A with process priority P1 may retrieve a queue list that includes queue identifiers with priority Q1 and include queue identifier “120F” in the queue list. In this way, as long as the number of queue identifiers in queue list is less than the queue limit of process 122A, process 122A may process queue 120F instead of process 122B, as illustrated in FIG. 2B. As further illustrated, process 122B may process the first set of queues that includes queues 120G-I.

In an embodiment, processes 122A and 122C may also repeat the process discussed above for process 122B and determine whether process 122A may process queues 120A-F and process 122C may process queues 120J-K as discussed above. For example, process 122A may determine that process 122A may process queues 120A-E, and queue 120F from process 122B, because process 122A has a queue limit=6. In another example, process 122C may determine that process 122C may process queues 120J-K because process 122C has a queue limit=2.

In an embodiment, once respective processes 122A-C determine that process 122A-C may process queues 120A-F, process 122B may process queues 120G-I and process 122C may process queues 120J-K, processes 122A-C may process respective queues 120A-K for one or more configurable cycles. During the processing, processes 122A-C may retrieve messages 112A-K from the respective queues 120A-K and process messages 112A-K, by for example, transmitting messages 112A-K to various destinations. Notably, as processes 122A-C retrieve and process messages 112A-K from queues 120A-K, new messages 112 may arrive at distribution server 109 and be added to queues 120A-K.

At the end of the one or more cycles, processes 122A-C may re-evaluate the queue processing for queues 120A-K to determine whether one or more queues in queues 120A-K begin to lag or are lagging and should be reallocated between processes 122A-C. As will be discussed below, a process in processes 122A-C may reallocate queues 120A-K when one or more queues in queues 120A-K may include more messages 112A-K after the one or more cycles complete than before the one or more cycles. This indicates that a process in processes 122A-C with different resource allocation may be more efficient at processing the one or more queues in queues 120A-K.

To determine whether to reallocate the one or more queues in queues 120A-K, processes 122A-C may again determine batch numbers for queues 120A-K. If the batch number for a queue in queues 120A-K increased from the before the processing, processes 122A-C may increase the queue priority of that queue in memory storage 118. For example, process 122B may determine that the batch number for queue 120G after the processing for the one or more cycles is 40, while before the processing the batch number for queue 120G was 30 as discussed above. Because the batch number for queue 120G has increased, process 122B may determine that queue 120G may begin to lag and increase queue priority for queue 120G from Q2 to Q3 in memory storage 118. In this way, queue 120G may be processed using process 122C during the next one or more cycles as illustrated in FIG. 2C. As discussed above, process 122C may have access to more resources in resources 124 in distribution server 109 than process 122B, and also have a lower queue limit. As discussed above, these factors may cause process 122C to process messages 112G in queue 120G faster than process 122B.

In another example, if the batch number of a queue in queues 120A-K has a batch number that is equal to zero (or less than a configurable minimum batch number threshold), processes 122A-C may set the queue priority for that queue to a default queue priority, such as Q0. For example, process 122C may determine that the batch number for queue 120J is zero and set the queue priority of queue 120J to zero in memory storage 118. In this case, queue 120J may be processed using a process associated with the lowest process priority P0, such as process 122D, as also illustrated in FIG. 2C.

In another example, if a batch number of a queue in queues 120A-K remains the same or has decreased after the processing for one or more cycles but is above zero (or the configurable minimum batch number threshold), processes 122A-C may not change the queue priority of the queue. This is illustrated with queues 120A-F, 120H-I, and 120K, which continue to be processed using respective processes 122A, 122B, and 122C during the next one or more cycles, as illustrated in FIG. 2C. This is because process 122A does not change queue priorities of queues 120A-F, process 122B does not change queue priorities of queues 120H-I, and process 122C does not change queue priority of queues 120K.

In an embodiment, once processes 122A-C reallocate queues 120A-K, processes 122A-D may again process queues 120A-K for another one or more cycles. After the one or more cycles complete, processes 122A-D may again determine whether to reallocate queues 120A-K among processes 122A-D based on the number of messages 112A-K in the respective queues 120A-K.

Going back to FIG. 1, in an embodiment, distribution server 109 may add additional processes 122 to process queues 120. For example, as distribution server 109 receives more and more messages 112 from different message servers 106, distribution server 109 may instantiate new queues and add the new queues to queues 120. For example, as illustrated in FIG. 2D, distribution server 109 may add queues 120L-N to process messages 112L-N. In an embodiment, newly added queues 120L-N may have initial queue priority of Q0. In this way, queues 120L-N may initially be processed by process 122D. As discussed above, because process 122D has a process priority P0, which is the lowest priority, process 122D may process an unlimited number of queues 120. Accordingly, in FIG. 2D, process 122D may process queues 120J, 120L, 120M, and 120N.

Going back to FIG. 1, in an embodiment, distribution server 109 may also add additional processes to processes 122. For example, suppose queue 120K continues to show a processing spike that indicates that the batch number of queue 120K continues to increase, even though queue 120K is being processed using process 122C that has the highest process priority P3. In this case, distribution server 109 may instantiate a new process 122E that has a process priority P4 and queue limit=1. As discussed above, process 122E may have more resources from resources 124 than resources from resources 124 that are allocated to each of processes 122A-D because processes 122A-D have lower process priorities than process 122E. Additionally, process 122C may increase queue priority for queue 120K to Q4. In this way, process 122E may generate a list of queues that includes queue identifiers for queues with queue priorities Q4. In the example above, the list of queues may include queue identifier “120K.” As such, process 122E may process queue 120K as illustrated in FIG. 2E.

In an embodiment, because process 122E may have a highest process priority from processes 122A-E, process 122E may generate a list of queues that includes queues 120 with queue priorities (such as Q4) that match the highest process priority (such as P4) and that have higher queue priorities, such as Q5, Q6, etc., (not shown).

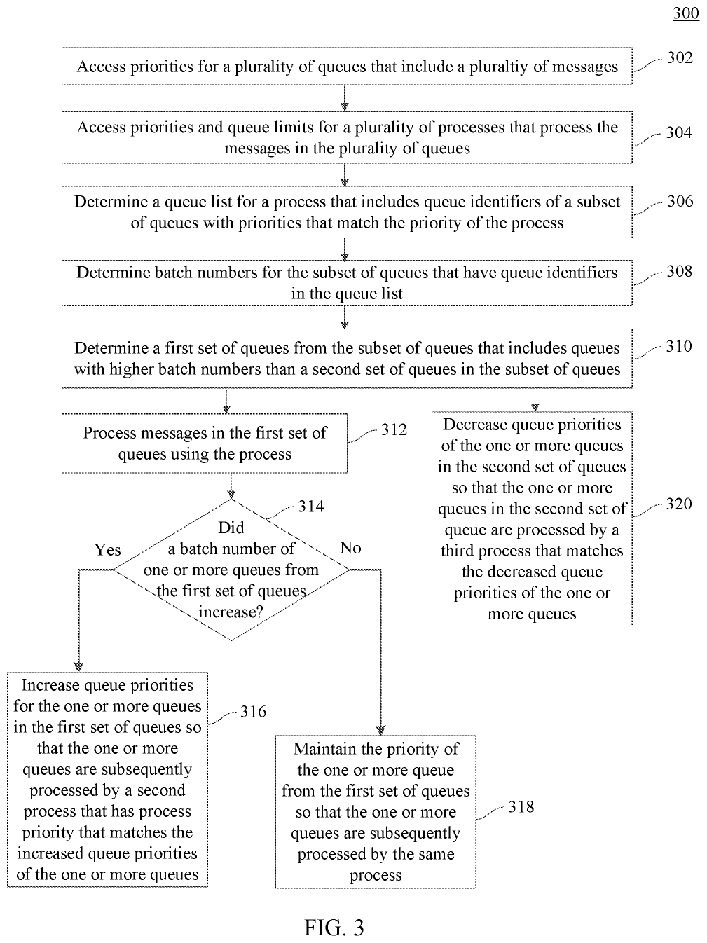

FIG. 3 is a flowchart of a method 300 for allocating queues to processes, according to an embodiment. Method 300 may be performed using hardware and/or software components described in FIGS. 1-2. Note that one or more of the operations may be deleted, combined, or performed in a different order as appropriate.

At operation 302, queue priorities for queues are accessed. For example, processes 122A-C may access queue priorities of queues 120A-K that receive and store messages 112A-K from message server(s) 106. As discussed above, distribution server 109 may store queue priorities for queues 120A-K in memory storage 118.

At operation 304, process priorities and queue limits are accessed. For example, processes 122A-C may access process priorities and queue limits associated with processes 122A-C. As discussed above, processes 122A-C store process priorities and queue limits in processes 122A-C or within memory storage 118 of distribution server 109.

At operation 306, a queue list for each process is determined. For example, processes 122A-C may match generate queue lists that include queue identifiers of queues 120A-K with queue priorities that match the process priorities of processes 122A-C. As illustrated in FIG. 2B, the queue list for process 122B may have queue identifiers “120F-I” for queues 120F-I.

At operation 308, the batch numbers for queues in the list of queues are determined. For example, process 122B may determine a batch number for each of queues 120F, 120G, 120H, and 120I by dividing messages 112F, 112G, 112H, and 112I in the respective queues 120F, 120G, 120H, and 120I by the configurable batch number size.

At operation 310, a first set of queues and a second set of queues from the list of queues are determined. As discussed above, process 122B may determine the first set of queues from the list of queues that includes queues up to a queue limit. For example, as discussed above, process 122B has a queue limit=3, and queue 120F has a batch number=20, queue 120G has a batch number=30, queue 120H has a batch number=22, and queue 120I has a batch number=40. Because process 122B has a queue limit=3, process 122B may determine that the first set of queues may include queues 120G, 120H, and 120I that correspond to queue identifiers “120G-I”, and the second set of queues may include queue 120F that has a lower batch number than queues 120G, 120H, and 120I that corresponds to queue identifier “120F”. The processing of the first set of queues is described at operation 312 and the processing of the second set of queues is described at operation 314.

At operation, 312, the queues in the first set of queues are processed. For example, process 122B may process messages 112G in queue 120G, messages 112H in queue 120H, and messages 112I in queue 120I in the first set of queues for a configurable number of cycles or for a configurable time interval. As also discussed above, as process 122B processes messages 112G-I in queues 120G-I, queues 120G-I may receive new messages that are stored in queues 120G-I in the FIFO fashion.

At operation 314, a determination is made whether a batch number of one or more queues in the first set of queues has increased after the processing in operation 312. For example, if the batch number of a queue, such as queue 120G is 40 after the processing, while at operation 310 the batch number of queue 120G was 30, the batch number increased indicating that queue 120G begins to lag. If the batch number of the queue increased, method 300 proceeds to operation 316. In another example, if the batch number of a queue, such as queue 120H is 20 after the processing, while at operation 310 the batch number was 30, method 300 proceeds to operation 318. In the example, if the batch number of a queue, such as queue 120I, after the processing is 40, while at operation 310 the batch number was 40, the method also proceeds to operation 318.

At operation 316, the queue priority of the one or more queues in the first set of queues is increased. For example, process 122B may increase queue priority of queue 120G from Q2 to Q3 and store the increased queue priority in memory storage 118. This is because process 122B may determine that queue 120G begins to lag due to a number of new messages 112 that are being written into queue 120G and may need more resources for processing than resources available to process 122B. In this way, during the next one or more cycles, queue 120G may be processed using process 122C that has process priority P3 and that matches queue priority Q3, and that has more resources than process 122B.

At operation 318, the queue priority of the one or more queues in the first set of queues is maintained. For example, process 122B may maintain queue priority for queues 120H and 120I at Q2 because the batch numbers for queues 120H and 120I have decreased or remained the same, indicating that process 122B has enough resources to process queues 120H and 120I without queues 120H and 120I beginning to lag. In this way, during the next one or more cycles, queues 120H and 120I may be processed using process 122B.

As discussed above, method 300 proceeds to operation 320 that processes the second set of queues that includes queue 120F from the subset of queues that includes queues 120F-I. As also discussed above, the second set of queues includes one or more queues that have batch numbers that are lower than the batch numbers of the queues in the first set of queues, indicating that the second set of queues may be processed using less resources than the first set of queues. At operation 320, queue priority of the one or more queues in the second set of queues is decreased. For example, process 122B may decrease the queue priority of queue 120F in the second set of queues from Q2 to Q1 and store the decreased queue priority in memory storage 118. This is because process 122B has reached the queue limit that indicates the number of queues 120 that process 122B may process during a processing cycle. In this way, queue 120F may be processed using process 122A that has process priority of Q1 and that has fewer allocated resources from resources 124 than process 122B.

Although method 300 describes the queue processing for queues 120F-I from queues 120A-K, the embodiment is not limited to queues 120F-I and method 300 may also apply to other queues included in queues 120A-K that were not described in method 300.

Referring now to FIG. 4 an embodiment of a computer system 400 suitable for implementing, the systems and methods described in FIGS. 1-3 is illustrated.

In accordance with various embodiments of the disclosure, computer system 400, such as a computer and/or a server, includes a bus 402 or other communication mechanism for communicating information, which interconnects subsystems and components, such as a processing component 404 (e.g., processor, micro-controller, digital signal processor (DSP), graphics processing unit (GPU), etc.), a system memory component 406 (e.g., RAM), a static storage component 408 (e.g., ROM), a disk drive component 410 (e.g., magnetic or optical), a network interface component 412 (e.g., modem or Ethernet card), a display component 414 (e.g., CRT or LCD), an input component 418 (e.g., keyboard, keypad, or virtual keyboard), a cursor control component 420 (e.g., mouse, pointer, or trackball), a location determination component 422 (e.g., a Global Positioning System (GPS) device as illustrated, a cell tower triangulation device, and/or a variety of other location determination devices known in the art), and/or a camera component 423. In one implementation, the disk drive component 410 may comprise a database having one or more disk drive components.

In accordance with embodiments of the disclosure, the computer system 400 performs specific operations by the processor 404 executing one or more sequences of instructions contained in the memory component 406, such as described herein with respect to the mobile communications devices, mobile devices, and/or servers. Such instructions may be read into the system memory component 406 from another computer readable medium, such as the static storage component 408 or the disk drive component 410. In other embodiments, hard-wired circuitry may be used in place of or in combination with software instructions to implement the disclosure.

Logic may be encoded in a computer readable medium, which may refer to any medium that participates in providing instructions to the processor 404 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 410, volatile media includes dynamic memory, such as the system memory component 406, and transmission media includes coaxial cables, copper wire, and fiber optics, including wires that comprise the bus 402. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 400. In various other embodiments of the disclosure, a plurality of the computer systems 400 coupled by a communication link 424 to the network 102 (e.g., such as a LAN, WLAN, PTSN, and/or various other wired or wireless networks, including telecommunications, mobile, and cellular phone networks) may perform instruction sequences to practice the disclosure in coordination with one another.

The computer system 400 may transmit and receive messages, data, information and instructions, including one or more programs (i.e., application code) through the communication link 424 and the network interface component 412. The network interface component 412 may include an antenna, either separate or integrated, to enable transmission and reception via the communication link 424. Received program code may be executed by processor 404 as received and/or stored in disk drive component 410 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the scope of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

What is claimed is:

1. A method comprising:
accessing, using a computer system, priorities for a plurality of queues;
accessing, using the computer system, priorities and queue limits for a plurality of processes, wherein the plurality of processes are configured to process messages in the plurality of queues;
determining a list of queues, the list of queues having queue identifiers of a set of queues in the plurality of queues with priorities that match a priority of a first process in the plurality of processes;
determining batch numbers of a set of queues having identifiers in the list of queues, each batch number of the batch numbers indicating a number of groups of messages to be processed from each queue of the set of queues;
determining a plurality of first queues from the set of queues up to a queue limit of the first process, wherein the plurality of first queues have higher batch numbers than one or more other queues in the set of queues;
processing the plurality of first queues using the first process over a configurable time interval, wherein processing the plurality of first queues includes transmitting content in messages in the plurality of first queues to a plurality of destinations;
determining that a batch number for a first queue in the first plurality of queues increased after the processing for the configurable time interval, indicating that a total number of messages in the first queue has increased from before to the processing; and
in response to determining that the batch number has increased, increasing the priority of the first queue.

2. The method of claim 1, further comprising:
responsive to increasing the priority, processing the first queue using a second process that has a higher priority in the priorities associated with the plurality of processes than the first process and wherein the higher priority of the second process indicates that there are more resources assigned to the second process than to the first process.

3. The method of claim 2, wherein the second process has a lower queue limit than the first process, and wherein the lower queue limit of the second process indicates that the second process processes fewer queues in the plurality of queues than the first process.

4. The method of claim 1, wherein the configurable time interval includes a configurable number of execution cycles of a processor.

5. The method of claim 1, further comprising:
decreasing a priority of the one or more other queues in the plurality of first queues; and
processing the one or more other queues using a third process associated with a priority that matches the decreased priority of the other queues.

6. The method of claim 1, further comprising:
determining that messages in a second queue of the plurality of first queues have been processed during the configurable time interval;
setting a priority of the second queue to zero; and
processing the second queue using a fourth process associated with a priority that matches the priority of the second queue.

7. The method of claim 1, further comprising:
determining that a batch number of a third queue in the plurality of first queues decreased after the processing the plurality of first queues for the configurable time interval, indicating that a number of messages in the third queue have decreased since prior to the processing the plurality of first queues;
retaining a priority of the third queue; and
processing the third queue using the first process.

8. The method of claim 1, wherein the queue limit identifies a number of queues that the first process can process in the configurable time interval.

9. The method of claim 1, wherein determining the batch number for the first queue further comprises:
identifying a number of messages in the first queue that the first process can process; and
dividing the number of messages by a configurable batch size.

10. The method of claim 1, further comprising:
setting the priorities for the plurality of processes, wherein each priority corresponds to resources assigned to each process in the plurality of processes to process the plurality of queues over the configurable time interval.

11. The method of claim 1, wherein the messages in the plurality of queues are from multiple sources that are destined to the plurality of destinations.

12. The method of claim 1, wherein the messages in the plurality of queues include a first message with a first content and a second message with a second content different from the first content.

13. The method of claim 1, wherein the messages in the plurality of queues include a first message that lays out first content according to a template and a second message that lays out second content, different from the first content, according to the template.

14. A system, comprising:
a non-transitory memory storing instructions; and
one or more hardware processors coupled to the non-transitory memory and configured to read the instructions from the non-transitory memory to cause the system to perform operations comprising:
determining priorities for a plurality of queues;
determining priorities and queue limits for a plurality of processes, wherein the plurality of processes are configured to process messages in the plurality of queues, the messages including content to be viewed at a plurality of computing devices;
determining a set of queues from the plurality of queues, the set of queues having priorities that match a priority of a first process in the plurality of processes;
determining batch numbers for the set of queues, each batch number of the batch numbers indicating a number of groups of messages to be processed from each queue of the set of queues;
determining one or more first queues from the set of queues up to a queue limit of the first process, wherein the one or more first queues have higher batch numbers than one or more second queues in the set of queues;
processing the one or more first queues using the first process over a configurable time interval; and
processing the one or more second queues using a second process of the configurable time interval.

15. The system of claim 14, wherein the operations further comprise:
determining that a batch number for a first queue in the first one or more queues increased after the processing the first one or more queues for the configurable time interval, indicating that a total number of messages in the first queue has increased from before processing the one or more first queues;
in response to determining that the batch number has increased, increasing the priority of the first queue; and
processing the first queue using a third process that has a higher priority than the first process.

16. The system of claim 14, wherein processing the one or more of first queues includes transmitting content from messages in the one or more first queues to a plurality of destinations.

17. The system of claim 14, wherein the operations further comprise:
determining that a batch number for a first queue in the second one or more queues decreased after the processing the second one or more queues for the configurable time interval, indicating that a total number of messages in the first queue has decreased; and
processing the first queue using the second process for a next configurable time interval.

18. A non-transitory machine-readable medium having stored thereon machine-readable instructions executable to cause a machine to perform operations comprising:
accessing, using a computer system, priorities for a plurality of queues, the plurality of queues storing messages that include content;
accessing, using the computer system, priorities and queue limits for a plurality of processes, wherein the plurality of processes are configured to process the messages in the plurality of queues;
determining a list of queues, the list of queues having queue identifiers of a set of queues in the plurality of queues with priorities that match a priority of a first process in the plurality of processes;
determining batch numbers in the set of queues having the queue identifiers in the list of queues, each batch number of the batch numbers indicating a number of groups of messages to be processed from each queue of the set of queues;
determining a plurality of first queues from the set of queues up to a queue limit of the first process, wherein the plurality of first queues have higher batch numbers than one or more other queues in the set of queues;
processing the plurality of first queues using the first process over a configurable time interval, wherein processing the plurality of first queues includes transmitting the content in the messages in the plurality of first queues to a plurality of destinations;
determining that a batch number for a first queue in the first plurality of queues increased after the processing for the configurable time interval, indicating that a total number of messages in the first queue has increased from before to the processing; and
in response to determining that the batch number has increased, increasing the priority of the first queue

19. The non-transitory machine-readable medium of claim 18, wherein the machine readable instructions cause the machine to further perform operations comprising:
decrementing queue priorities of the one or more other queues in the set of queues;
processing the one or more other queues in the set of queues using a second process in the plurality of processes that is associated with a priority that matches decremented queue priorities of the one or more other queues;
determining that a batch number for a second queue in the one or more other queues increased after the processing the one or more other queues for the configurable time interval, indicating that a total number of messages in the second queue has increased;
incrementing queue priority of the second queue; and
processing the second queue using the first process for a next configurable time interval.

20. The non-transitory machine-readable medium of claim 18, wherein a first message in the messages includes first content formatted using a template, and a second message in the messages includes second content formatted using the template.
